(19) United States
(12) Patent Application Publication
(10) Pub. No.: US 2007/0277845 A1
(43) Pub. Date: Dec. 6, 2007

(54) Dental thread contained into a closed envelope and disposable therewith

(76) Inventor: Alfredo Carlos C. Blasco, Mar Del Plata (AR)

Correspondence Address: JACOBSON HOLMAN PLLC, 400 SEVENTH STREET N.W., SUITE 600, WASHINGTON, DC, 20004, US

(21) Appl. No.: 11/509,811

(22) Filed: Aug. 25, 2006

(30) Foreign Application Priority Data
Jun. 5, 2006 (AR) M20060102347

(51) Int. Cl. A61C 15/00

(52) U.S. Cl. 132/321

(57) ABSTRACT

Dental thread contained into a closed envelope and disposable therewith, particularly having the suitable length to be used only once. The thread is contained into an envelope having at least two opposite sides closed along respective edge regions and having at least one of its end portions fixed to one of said edge regions.

The instant utility model relates to a dental thread contained into a closed envelope and disposable therewith; particularly, the thread has a length suitable to be used only once.

According to the prior art, dental threads are supplied in an enclosed bobbin in order that the user may cut the required length to clean dental interstices.

Therefore, the fact of supplying dental thread into a closed envelope containing only the length of thread to be used once is advantageous since it may be easily carried into a pocket or a handbag under optimum preservation conditions until it is used, avoiding pollution upon being disposed into its original container.

Further, to avoid the dental thread from falling down when the envelope is opened, it is fixed within the envelope by at least one of its ends.

Thus, envelopes having two opposite sides closed by heat-sealing along respective edge regions are preferred. By means of this procedure, advantage is taken of the fixation of the ends of the dental thread which could be then extended for use towards any of said two edge regions when one of said heat-sealed edge regions is cut and manually separated.

Another advantage is the fact that the open envelope and the already used dental thread may be disposed off at the same time, the thread being re-introduced within the envelope to comply with elemental rules of environmental hygiene.

The utility model will be now described with reference to an exemplary embodiment considering the attached drawings, in which:

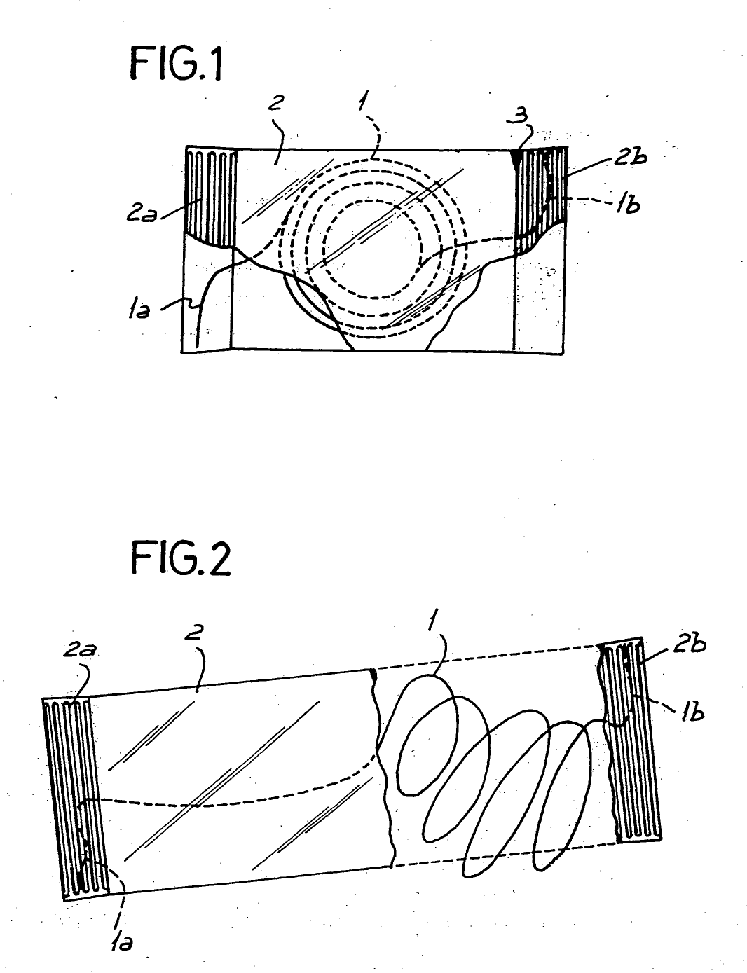

FIG. 1 is a front elevation with partial cross sections of the envelope containing the dental thread, and

FIG. 2 is a perspective view of the envelope when opened along one of the heat-sealed edge regions which, upon being separated, drags the dental thread fixed thereto.

In both figures the same reference symbols designate the same or corresponding parts.

According to the drawings, dental thread 1 is rolled up and contained into envelope 2 whose sides, left side 2a and right side 2b, are closed by heat-sealing the retaining end portions 1a and 1b of dental thread 1.

To use the dental thread 1 the user should simply cut the envelope 2 along any of the edge regions, left region 2a or right region 2b by tearing along the heat-sealed portion thus separating this portion to unwrap the dental thread 1.

Additionally, a cut indication, such as a stripe, arrow, scissors or triangle 3 shown may be included on the container.

Obviously, a single end of the dental thread may be fixed to the envelope. In this case the user's hand may grasp the envelope containing the major part of the thread with one hand and with the other cut and separate said end to unwrap said dental thread.

In both cases, after use, dental thread 1 may be returned to the container 2 to be disposed off thus preserving hygiene.

However, it would be also convenient to provide a free end portion of the dental thread to be manually grasped by the user, the other portion being fixed at the corresponding edge region of envelope 2, in order to avoid falling of the dental thread 1 to the floor when said envelope is opened.

1. Dental thread contained into a closed envelope and disposable therewith, particularly having the suitable length to be used only once, characterized by being contained into an envelope having at least two opposite sides closed along respective edge regions and having at least one of its end portions fixed to one of said edge regions.

2. Dental thread as claimed in claim 1, characterized in that it is rolled up within an envelope which heat-sealed along said edge regions.

3. Dental thread as claimed in claim 1, characterized in that a cut indication or signal is included on the edge region wherein the end portion of the dental thread is fixed.

4. Dental thread as claimed in claim 1, characterized in that the two end portions are fixed within respective edge regions.
